(19) United States
(12) Patent Application Publication
(10) Pub. No.: US 2026/0229628 A1
(43) Pub. Date: Aug. 6, 2026

(54) THERMAL REGULATION DEVICE, AND CHARGING DEVICE COMPRISING A THERMAL REGULATION DEVICE

(71) Applicant: VALEO SYSTEMES THERMIQUES, Le Mesnil-Saint-Denis (FR)

(72) Inventors: Roberto FERNANDEZ, Zaragoza (ES); Philippe OGER, Le Mesnil- Saint-Denis Cedex (FR); Jesus JIMENEZ, Zaragoza (ES); Jean-Louis LANARD, Le Mesnil- Saint-Denis Cedex (FR); Boris BARRE, Le Mesnil- Saint-Denis Cedex (FR)

(73) Assignee: VALEO SYSTEMES THERMIQUES, Le Mesnil-Saint-Denis (FR)

(21) Appl. No.: 19/158,290

(22) PCT Filed: Feb. 28, 2024
(86) PCT No.: PCT/EP2024/055123

§ 371 Date: Aug. 20, 2025

(30) Foreign Application Priority Data
Mar. 1, 2023 (FR) FR2301885

(51) Int. Cl. H01M 10/613; H01M 10/625; H01M 10/6554; H01M 10/6556; H01M 10/6568

(52) U.S. Cl. CPC H01M 10/613; H01M 10/625; H01M 10/6554; H01M 10/6556; H01M 10/6568

(57) ABSTRACT

A device for thermal regulation, in particular for cooling, for an electrical component that is liable to release heat during its operation, in particular for an electrical energy storage module. The device includes a first plate and a second plate, which is assembled with the first plate, each being delimited by edges, in order to form together a plurality of circulation channels for a heat-exchange fluid, in particular a refrigerant fluid. The plurality of channels define a channel zone, and the two plates are assembled by laser welding, preferably transmission laser welding, at the channel zone. The device includes an additional joining means, which is different than the transmission laser weld and which connects the edges of at least one plate to the other plate.

The present invention relates to a device for thermal regulation, in particular for cooling, in particular for an electrical component that is liable to release heat during its operation, in particular to a device for cooling at least one battery or battery cells of a vehicle, for example a motor vehicle.

The vehicle may be a land vehicle, a marine vehicle or an aerial vehicle.

The components to which the present invention relates may be electrical energy storage elements, in particular battery elements, or power electronics elements, for example but not limited to semiconductors such as diodes or transistors. They could also be components of computer servers.

The electrical or electronic systems, for example electrical energy storage devices in a motor vehicle or computer servers, may be subject to significant constraints because of a need to supply an element that requires a large amount of energy or because of the need to perform significant processing of information in a very short time. Thus, when these electrical or electronic systems are heavily used, they are liable to release a large amount of heat and therefore reach high temperatures, which reduce the service life of said electrical or electronic systems.

In order to limit the temperature of the electrical or electronic systems, it is known to provide cooling devices associated with these systems. Such cooling devices are arranged in the vicinity of the parts of the electrical or electronic system that release heat, and a cooling fluid flows through them, the temperature of which makes it possible to exchange heat with these parts and to cool them. These cooling devices may in particular be plate devices, which are obtained by assembling at least two pressed plates that are welded to one another in order to form channels between said plates, said channels making it possible for the cooling fluid to circulate.

The invention relates in particular to plate heat exchangers intended for the circulation of a refrigerant fluid for cooling the batteries of hybrid or electric vehicles.

Industrially, these exchangers are generally made from metallic materials and are assembled by brazing.

Although it is currently very widespread in the industry, the brazing method has disadvantages, in particular that of the carbon footprint of such a manufacturing method, so that alternative solutions for joining two plates have gradually been proposed with the aim of reducing in particular the electrical consumption and therefore the emissions generated indirectly by such a method, one of them being to assemble the two plates by welding, in particular by laser welding.

The laser welding method has several advantages. Specifically, such a method is less energy-intensive and less polluting than welding by brazing. It allows a reliable joint to be made without leaks, particularly in straight lines. However, heat exchangers comprise other types of paths, such as bends, loops and other complex paths.

These paths, in which the direction of the laser beam changes, are more sensitive to welding defects such as cracks, which may lead to leaks.

Clients' mechanical requirements relating to battery coolers are increasing in number, and the mechanical behavior of the cooler has become an important subject.

The welding of the plates typically takes place from the interior of the cooler toward the exterior of the cooler, in order to be able to compensate for the expansions and deformations of the plates that are due to the preceding welds. This means that the surface of the plates may be deformed more, or it is more difficult to keep the two plates in contact, when moving further away from the center of the plates. This increases the risk of leaks.

Furthermore, such deformations may create spaces between the two plates in the zone that does not comprise channels. Thus, even without a leak, a heat exchanger assembled in this way comprises spaces in which moisture, dust or other elements may accumulate and cause problems, in particular corrosion problems, which will have the effect of increasing the future risk of a leak or mechanical weakening.

There is therefore a need to obtain heat exchangers that are durable, robust and free from leaks, and to do so with the aid of a more ecological, rapid and reliable method.

It is an object of the present invention at least partially to overcome one or more of the aforementioned drawbacks by providing a heat exchanger, the corrosion resistance of which is improved, in order to satisfy the requirements of durability, sealing and mechanical strength, while reducing the electricity consumption and the production of pollutants during assembly.

The welding track may, for example, correspond to the contour of each plate in order to prevent the cooling fluid from flowing out of the cooling device. The welding track may also be linear in order to define and isolate a fluid circulation channel or a plurality of fluid circulation channels from one another.

The invention thus relates to a device for thermal regulation, in particular for cooling, for an electrical component that is liable to release heat during its operation, in particular for an electrical energy storage module, this device having a first plate and a second plate, which is assembled with the first plate, each being delimited by edges, in order to form together a plurality of circulation channels for a heat-exchange fluid, in particular a refrigerant fluid, the plurality of channels defining a channel zone, the two plates being assembled by laser welding, preferably transmission laser welding, at the channel zone, the device being characterized in that the device comprises an additional joining means, which is different than the transmission laser weld and which connects the edges of at least one plate to the other plate.

The additional join thus makes it possible to improve the corrosion strength of the device where the transmission laser weld may be susceptible to this corrosion during aging and/or use of the device.

The term “assembled by laser welding at the channel zone” means that the two plates are fixed together at the channels so as to allow the heat-exchange fluid to circulate between the two parts.

According to one of the aspects of the invention, the two plates are assembled by transmission laser welding at the channel zone.

According to one of the aspects of the invention, the additional joining means is selected from among laser fillet joint welding, laser filler wire welding, glue or a combination thereof.

According to one of the aspects of the invention, the second plate, which is preferably plane, extends beyond the edges of the first plate, which is preferably pressed in order to form a part of the walls of the channels.

According to one of the aspects of the invention, the additional joining means connects the edges of at least one plate to a portion of the other plate that does not form the edges of said other plate.

According to one of the aspects of the invention, the additional joining means connects the plates edge-to-edge.

According to one of the aspects of the invention, the edges of at least one of the plates comprise a deformation forming a fold in the direction of the other plate.

According to one of the aspects of the invention, one of the two plates comprises a pressed section around the channel zone, which includes a glue that forms a gasket compressed between the two plates.

The invention also provides a method for assembling two plates in order to obtain a device for thermal regulation, in particular for cooling, for an electrical component that is liable to release heat during its operation, in particular for an electrical energy storage module, the method being characterized in that it comprises the following steps,
providing two plates, each delimited by edges, at least one of the plates being pressed in order to form a part of the walls of the channels so as to form, together with the other plate, a plurality of circulation channels for a heat-exchange fluid, in particular a refrigerant fluid, the plurality of channels defining a channel zone,
laser welding, preferably transmission laser welding, the two plates at the channel zone,
then joining the edges of one plate to the other plate by a different additional joining means.

According to one of the aspects of the invention, the method furthermore comprises an additional step of deforming the edges of one plate so as to form a fold toward the other plate.

According to one of the aspects of the invention, the method furthermore comprises a step of introducing glue that forms a joint in the pressed wall with channels, defining the entire perimeter of the channel zone and forming a sealing channel, so that the glue is compressed by the two plates during their assembly, in particular followed by a step of heat-treating the glue in the pressed wall once the plates of the device have been assembled and said glue has been compressed.

According to one of the aspects of the invention, the method furthermore comprises a step of heat-treating the glue in the pressed wall once the plates of the device have been assembled and said glue has been compressed.

### DETAILED DESCRIPTION OF THE FIGURES

Other features and advantages of the invention will become clearer on reading the following description, which is provided by way of non-limiting illustrative example, and from the accompanying drawings, in which:

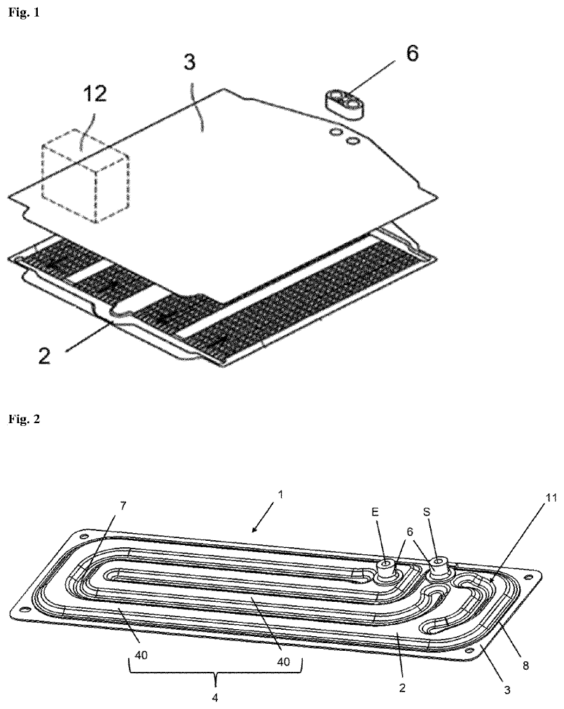

FIG. 1 schematically and partially illustrates a cooling device according to the prior art;

FIG. 2 schematically illustrates a device according to a first embodiment of the invention in a perspective view;

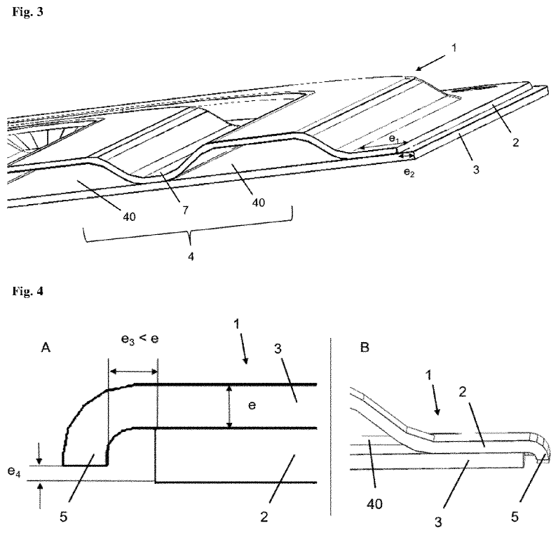

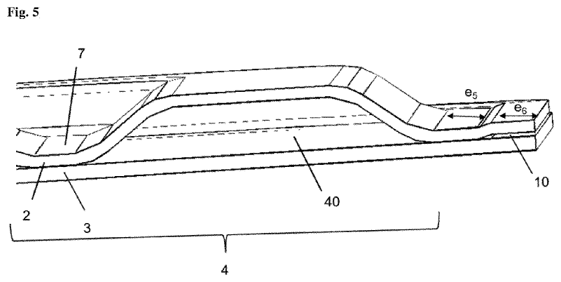

FIG. 3 schematically and partially illustrates a detail of the device according to a second embodiment of the invention in a sectional view;

FIG. 4 schematically and partially illustrates a detail of the device according to a third embodiment of the invention in a sectional view;

FIG. 5 schematically and partially illustrates a detail of the device according to a fourth embodiment of the invention in a sectional view.

### THERMAL REGULATION DEVICE

The invention relates in particular to the thermal regulation device 3 described in more detail below. It comprises a device for thermal regulation, in particular for cooling, for an electrical component that is liable to release heat during its operation, in particular for an electrical energy storage module, this device having a first plate (2) and a second plate (3), which is assembled with the first plate, each being delimited by edges, in order to form together a plurality of circulation channels (40) for a heat-exchange fluid, in particular a refrigerant fluid, the plurality of channels defining a channel zone (4), the two plates (2, 3) being assembled by laser welding, preferably transmission laser welding, at the channel zone, the device being characterized in that the device comprises an additional joining means, which is different than the transmission laser weld and which connects the edges of at least one plate (2, 3) to the other plate (2, 3).

Minor communication leaks between the two channels may be accepted because there is no loss of fluid to the exterior of the cooler, only an insignificant reduction of the thermal uniformity at the surface of the battery. External leaks, regardless of their location, are not acceptable. One of the weaknesses of transmission laser welding is that it requires perfect contact between the surfaces to be welded.

One of the internal requirements being to keep the manufacturing cycle time of the cooler as short as possible, the join between the channels is assumed in all cases to be made by transmission laser welding. The invention is applied to the perimeter of one of the two plates or in specific zones.

The device may furthermore have one or more of the features described below, taken separately or in combination.

The dimensions of the weld bead may be between 0.5 mm and 1.5 mm, preferably 0.75 mm and 1.25 mm.

The location of the join connecting the edges of one plate to the other plate is contingent on its position with respect to said edges, and depends on the position of the edges of the channels with respect to the edges of the plane plate. This distance between the join and the edge of the closest plate may vary from 0 to 5 cm, preferably 0.1 cm to 3 cm, more preferentially 0.1 cm to 1 cm.

It is to be understood here that the “edges” of the plate may be flat or pressed.

It is to be understood that laser fillet joint welding means welding without supplying material between the edge of one plate, preferably the pressed plate, and a flat zone of the other plate, preferably the upper flat plate. The laser is used to melt the material of the plates in order to produce the weld between them.

In the case of laser filler wire welding, the welding for example may be carried out with the same position of the plates, but a filler wire is melted in order to supply the material that will form the weld bead.

FIG. 1 represents a thermal regulation device 1 of the prior art, having a set of battery cells 12 to be cooled, for example aligned along two or more rows, which are in thermal contact with an upper plate 3 of the thermal regulation device 1. The device 1 comprises a pressed plate 2 and a plane plate 3, between which the heat-exchange fluid passes through channels. Most devices of this type are assembled by brazing in large furnaces, which presents several drawbacks, in particular the cost of such furnaces and their carbon footprint during operation.

FIG. 2 presents an exemplary embodiment of the thermal regulation device 1 comprising a first plate 2, which is preferably pressed, and a second plate 3, which is preferably plane. The channels 40 of the channel zone 4 can be seen; they are configured to contain a heat-exchange fluid which flows through said channels 40. One plate is fixed on the other at the channel zone 4 by transmission laser welding, while an additional joining means different than the transmission laser weld connects the edges of at least one plate (2, 3) to the other plate (2, 3).

In certain embodiments, as represented by way of example and without limitation in FIG. 3, the pressed plate 2 and the plane plate 3 are connected by a joining means at the edges of one plate, here the pressed plate 2, onto another plate, here the plane plate 3, over a line at a distance from the edge of said plane plate 3.

The plane plate 3 thus extends beyond the edges of the other, pressed plate 2.

This advantageously makes it possible to reduce the weight of the device, because the plate whose edges are fixed to the other plate is smaller than the other plate. It furthermore makes it possible to use the larger plate as a screen for protecting the join from some of the impurities of the environment, in order to improve the corrosion resistance.

In certain embodiments, the joining means at the edges of the first plate has a length e1, the second plate extending beyond the edges of the first plate (2) over a length e2 of between 30% and 70% of the length e1, preferably between 40% and 60% of the length e1, preferably 50% of the length e1.

This advantageously makes it possible, in particular, to reduce the weight of the device while benefiting from the protection against corrosion, and to do so optimally.

The use of a joining means different than the laser weld, in particular the transmission laser weld, furthermore makes it possible to improve the sealing of the plate by overcoming the drawbacks inherent in laser welding, for example transmission laser welding.

In certain embodiments, as represented by way of example and without limitation in FIGS. 4A and 4B, one of the plates (2, 3) extends beyond the other plate (3, 2), the plate that extends beyond the other plate comprising a deformation (5) forming a fold in the direction of the other plate (2, 3).

This advantageously makes it possible to improve the corrosion resistance by forming a corner that acts as a shield covering the joint, which prevents moisture and dust from coming into contact with the latter.

It also advantageously makes it possible to reduce the effects of the deformations that are due to the laser welding join produced in the channel zone.

In certain embodiments, the fold forms an angle of between 75° and 105°, preferably 90°. The angle is preferably formed over a plate length e3 whose value is less than the thickness e of the plate from which the fold originates.

In certain embodiments, the fold does not entirely cover the plate toward which the fold is directed; the plate covered in this way preferably has in front view an uncovered thickness with a value e 4 at least equal to or greater than 0.1 mm.

The term “cover” means that the fold of a plate is placed facing the plate in the direction of which it is folded, this facing placement preferably being partial, the second plate then having at least a thickness without overlapping the fold with a value e4 at least equal to or greater than 0.1 mm.

In certain embodiments, as represented in FIG. 4A, the second, plane upper plate 3 comprises the deformation 5 forming a fold.

In certain embodiments, as represented in FIG. 4B, the first pressed plate 2 comprises the deformation 5 forming a fold.

This advantageously makes it possible to reduce the risks of dust, debris or moisture being able to enter between the two plates.

This also advantageously makes it possible to reduce the effects of the deformations that are due to the laser welding join produced in the channel zone.

The deformation of the first pressed plate in order to form the channels is generally carried out by pressing with deformation. The length of the deformation, in the direction of the second plate, to which the first plate is intended to be joined, should not exceed the thickness of said second plate. When the plates are being joined, the laser welding creates stresses, for which reason it is advantageous to have solid external welds.

In certain embodiments, the laser welding takes place from the interior of the plate, for instance the center, toward the exterior, in order to be able to optimally manage said stresses created by the deformation then welding of the plates.

In certain embodiments, as represented by way of example and without limitation in FIG. 5, one of the two plates comprises a pressed section 11 around the channel zone 4, which includes an adhesive 10 such as glue that forms a gasket compressed between the two plates (2, 3).

The pressed section 11 is preferably bordered on at least one side, preferably on the side closest to the center of the device 1, by a join between the two plates. The join located between the channel zone 4 and the gasket 9 may, for example, be produced by laser welding, in particular transmission laser welding.

In certain embodiments, the length e6 of the joining means 8, formed by a pressed section 11 including an adhesive 10, is less than the length e5 of the join between the two plates bordering said joining means 8. In certain embodiments, the length e6 is less than 2 mm and the length e5 is less than 2.5 mm.

It is to be understood that the lengths e1, e2, e3, e4, e5 and e6 are measured at a given point along the direction perpendicular to the main direction in which it has extended to this point.

In certain embodiments (not represented), the device may be produced in a plurality of steps. A first production step consists in joining one edge of one plate, here the pressed first plate 2, onto the other plate, here the second plate 3, at a portion of the second plate 3 that does not form the edges of said second plate 3. A second step consists in removing the portion of the second plate, which is contained between the join between the first and second plates and the edges of the second plate, so that the second plate does not extend beyond the first plate, or alternatively beyond a length e2 of between 30% and 70% of the length e1, preferably between 40% and 60% of the length e1, preferably 50% of the length e1, the length e1 being the length of the additional joining means.

This advantageously allows a simple method for obtaining the device, while allowing a large number of joining options, in order to obtain a relatively lightweight device.

In certain embodiments, the first step of the method described above includes a laser fillet joint welding join.

Advantageously, this method makes it possible to produce a reliable laser fillet joint weld while maintaining a device that is compact and lightweight.

In certain embodiments, the additional joining means is an adhesive such as glue. It may be produced in the form of a bead at a pressed section produced around the perimeter of the pressed plate. In this case, the placement of the adhesive is preferably carried out before the welding operations.

The glue may be selected from among types of glue such as PU (polyurethane), epoxy or methacrylate.

In certain embodiments, the glue is crosslinked, for example by heat treatment, following its application in the device, the glue being made of EPDM, NBR or FKM.

In certain embodiments, the transmission laser welding is first carried out between the channels, then the second additional joining means that joins the edges of one plate to the other plate is produced. Producing the joins in this order advantageously reduces the deformations and stresses experienced by the assembled device.

Friction stir welding is a solid-state welding method which consists in assembling two parts while bringing them into a paste-like state by using a rotating pin. One example of such a method consists of a cylindrically shaped tool having a shoulder and a coaxial pin that rotates at a constant speed on the contact line between the parts to be welded, so as to cause “softening” of the materials, which become paste-like. The tool then penetrates into the plane of the joint and intimately mixes the materials. Complete assembly is obtained during the advance of the tool, which progressively covers the entire zone that is to be welded. The maximum temperatures reached during the method are below the melting temperature of the material: the friction stir welding method is therefore a solid-state welding method.

In certain embodiments, the device comprises a welding track that at least partially delimits the fluid circulation zone, and at least one weld bead, corresponding for example to the end of the welding track, is produced in contact with the welding track at at least one contact point, the welding track and the weld bead having a different curvature with respect to one another at said contact point.

By virtue of using a weld bead, the sealing of the cooling device is reliably ensured, and the stopping of the laser beam that carries out the welding does not affect the sealing of the cooling device. As will be described below, the weld bead may thus involve an additional welding operation which surrounds one end of the welding track and therefore ensures sealing around a zone potentially having leaks, which is formed by the end of the welding track, or it may involve extending the welding track in order to offset the risk of leakage, potentially due to the stopping of the laser beam, into a zone that is not problematic because it is far away from the fluid circulation zone.

In certain embodiments, the weld bead is established at least partially in contact with the welding track and constitutes an additional weld that reinforces the sealing of the cooling device. In other words, the weld bead doubles the sealing of the cooling device by making the welding track sealed. Thus, the cooling fluid cannot flow through a potential welding track because the weld bead either closes the welding track, while surrounding a potential weak point within the welding track, or extends the welding track in order to offset this potential weak point. In both of these cases, the sealing is ensured and guaranteed by virtue of the different curvature of the weld bead compared to that of the welding track at the point of contact between the weld bead and the welding track.

In certain embodiments, the weld bead forms an extension of the welding track. In other words, the weld bead is made in continuity with the welding track and the point of contact between the welding track and the weld bead corresponds to the join between the end of the welding track and the start of the weld bead. It is in particular by virtue of this extension by the weld bead that the sealing of the cooling device is ensured.

As mentioned above, the curvature is different between the welding track and the weld bead. Thus, starting from the point of contact, the weld bead deviates from a path established by the welding track.

In certain embodiments, the welding track has a closed profile, the weld bead having a free end at a distance from the closed profile of the welding track.

By way of example, the closed profile as defined by the welding track may correspond to the contour of the plates in order to prevent a flow of the cooling fluid out of the cooling device. In general, the closed profile may define a zone in which the cooling fluid should be contained, or conversely a zone into which the cooling fluid should not penetrate, for various reasons. For its part, the weld bead extends as far as the free end that deviates from the closed profile by virtue of the different curvature compared to that of the welding track. This extension, which forms a free end, makes it possible to interrupt the laser beam at a distance from the end of the welding track and thus not to generate sealing defects as mentioned above.

### LIST OF REFERENCE SIGNS

1. thermal regulation device
2. first plate, pressed
3. second plate, plane
4. channel zone
40. channel
5. deformation forming a fold
6. connectors
7. transmission laser weld
8. additional joining means
10. adhesive
11: pressed section
12. element, storage device, electrical component
E. fluid inlet
S. fluid outlet

1. A device for thermal regulation for an electrical component that is liable to release heat during its operation, this device having a first plate and a second plate, which is assembled with the first plate, each being delimited by edges, in order to form together a plurality of circulation channels for a heat-exchange fluid, in particular a refrigerant fluid, the plurality of channels defining a channel zone, the two plates being assembled by laser welding, preferably transmission laser welding, at the channel zone,
wherein the device comprises an additional joining means, which is different than the transmission laser weld and which connects the edges of at least one plate to the other plate.

2. The thermal regulation device as claimed in claim 1, wherein the additional joining means is selected from among laser fillet joint welding, laser filler wire welding, glue or a combination thereof.

3. The thermal regulation device as claimed in claim 1, wherein the second plate, which is preferably plane, extends beyond the edges of the first plate, which is preferably pressed in order to form a part of the walls of the channels.

4. The thermal regulation device as claimed in claim 1, wherein the additional joining means connects the edges of at least one plate to a portion of the other plate that does not form the edges of said other plate.

5. The thermal regulation device as claimed in claim 1, wherein the additional joining means connects the plates edge-to-edge.

6. The thermal regulation device as claimed in claim lone wherein the edges of at least one of the plates comprise a deformation (5)-forming a fold in the direction of the other plate.

7. The thermal regulation device as claimed in claim 1, one of the two plates comprises a pressed section around the channel zone which includes a glue that forms a gasket compressed between the two plates.

8. A method for assembling two plates in order to obtain a device for thermal regulation, in particular for cooling, for an electrical component that is liable to release heat during its operation, in particular for an electrical energy storage module, the method being wherein it comprises the following steps,
providing two plates, each delimited by edges, at least one of the plates being pressed in order to form a part of the walls of the channels so as to form, together with the other plate, a plurality of circulation channels for a heat-exchange fluid, in particular a refrigerant fluid, the plurality of channels defining a channel zone,
laser welding, preferably transmission laser welding, the two plates at the channel zone,
then joining the edges of one plate to the other plate by a different additional joining means.

9. The assembly method as claimed in claim 1, which furthermore comprises an additional step of deforming the edges of one plate so as to form a fold toward the other plate.

10. The assembly method as claimed in claim 1, which furthermore comprises a step of introducing glue that forms a joint in the pressed wall with channels, defining the entire perimeter of the channel zone and forming a sealing channel, so that the glue is compressed by the two plates during their assembly, in particular followed by a step of heat-treating the glue in the pressed wall once the plates of the device have been assembled and said glue has been compressed.

11. The thermal regulation device as claimed in claim 2, wherein the second plate, which is preferably plane, extends beyond the edges of the first plate, which is preferably pressed in order to form a part of the walls of the channels.

12. The thermal regulation device as claimed in claim 2, wherein the additional joining means connects the edges of at least one plate to a portion of the other plate that does not form the edges of said other plate.

13. The thermal regulation device as claimed in claim 2, wherein the additional joining means connects the plates edge-to-edge.

14. The thermal regulation device as claimed in claim 2, wherein the edges of at least one of the plates comprise a deformation forming a fold in the direction of the other plate.

15. The thermal regulation device as claimed in claim 2, wherein one of the two plates comprises a pressed section around the channel zone, which includes a glue that forms a gasket compressed between the two plates.

16. The assembly method as claimed in claim 2, which furthermore comprises an additional step of deforming the edges of one plate so as to form a fold toward the other plate.

17. The assembly method as claimed in claim 2, which furthermore comprises a step of introducing glue that forms a joint in the pressed wall with channels, defining the entire perimeter of the channel zone and forming a sealing channel, so that the glue is compressed by the two plates during their assembly, in particular followed by a step of heat-treating the glue in the pressed wall once the plates of the device have been assembled and said glue has been compressed.

18. The thermal regulation device as claimed in claim 3, wherein the additional joining means connects the edges of at least one plate to a portion of the other plate that does not form the edges of said other plate.

19. The thermal regulation device as claimed in claim 3, wherein the additional joining means connects the plates edge-to-edge.

20. The thermal regulation device as claimed in claim 3, wherein the edges of at least one of the plates comprise a deformation forming a fold in the direction of the other plate.
